(19) United States
(12) Patent Application Publication
(10) Pub. No.: US 2002/0054084 A1
(43) Pub. Date: May 9, 2002

(54) Customized browser system and method for direct access to a specified internet website

(76) Inventor: Brian Udell, Ft. Lauderdale, FL (US)

Correspondence Address: GREENBERG TRAURIG, P.A., 1221 Brickell Avenue, Miami, FL, 33131, US

(21) Appl. No.: 09/945,995

(22) Filed: Sep. 4, 2001

Related U.S. Application Data
(60) Provisional application No. 60/229,974, filed on Sep. 2, 2000.

(51) Int. Cl. G09G 5/00

(52) U.S. Cl. 345/738

(57) ABSTRACT

A customizable browser system and method for direct access to specified Internet websites. The browser's graphical elements and layout can be customized to suit the user's preferences or to match the specified website's graphical elements and layout. The system includes a software application that auto executes the browser system upon installation of the application—carrying media (e.g., a computer disk) into the computer system's media reader (e.g., a disk drive). The browser is simplified, having only the essential functions. The browser system makes the designated website the browser home page to which users return each time. The present invention provides a method for customized integration of the designated website's content with the browser.

### BACKGROUND OF THE INVENTION

1. Field of the Invention

The present invention relates to a streamlined system for the exchange of information and commerce via computer networks. More particularly, the present invention relates to a customized browser system and method for direct access to specified Internet websites.

2. Description of Related Art

The Internet is a network of computers communicating using common protocols, with each computer having a specific, unique address. There is an enormous amount of information available on the Internet, but it is often difficult for consumers to find. Internet usage and communications are typically accomplished through the use of a “browser.” A browser is a software application that facilitates an end user's communication with a particular address on the Internet, allowing linking to and downloading of files from the particular address. A modem is connected to a telephone line under control of a software application called a “dialer” in order to establish a telephonic connection to the Internet via an Internet service provider. Alternatively, connection to the Internet can be via an ISDN line or other direct Internet connection, local area network or wide area network.

With the dramatic growth of Internet usage, many businesses have developed websites to provide potential and existing customers with information about their business, products or services. Many also provide facilities for completing purchase and/or other business transactions online through the business' website.

Each website is designated by an Internet address in the form of a series of numbers such as “123.45.67.8.” In order to make website addresses easier to remember and more recognizable, domain names such as “www.xyz.com” have been developed to associate with the numerical addresses. Nevertheless, even domain names can be difficult to remember and enter correctly. Furthermore, with the huge growth in the number of websites on the Internet, competition for business is becoming more intense. A business with a simple and effective method for bringing a consumer to its website will have a competitive advantage over other businesses that lack such methods.

The present invention provides such a method and system.

### SUMMARY OF THE INVENTION

The present invention is a customizable browser system and method for direct access to specified Internet websites. The browser's graphical elements and layout can be customized to suit the user's preferences or to match the specified website's graphical elements and layout. The system includes a software application that auto executes the browser system upon installation of the application—carrying media (e.g., a computer disk) into the computer system's media reader (e.g., a disk drive) without the need for the user to take any further action, such as typing a command or clicking on an icon. The browser is simplified, having only the essential functions. The browser system makes the designated website the browser home page to which users return each time thereby providing a competitive advantage for businesses that utilize the present invention for promotional purposes. The present invention also includes a method for customized integration of the designated website's content with the browser.

Advantageous features of the system of the present invention are summarized as follows:

Customizable Elements

Users can customize buttons, colors and the graphical style of the browser user page display.

Self-running Auto-executable File

Users place the browser application-containing media in the appropriate reader and the browser application auto-executes, seeking Internet access and loading the appropriate uniform resource locator address of the desired website.

Simplified Browser

The browser lacks non-utilitarian buttons such as refresh, favorites and history. Browser buttons appear and disappear in context sensitive way. Browser is customized for the specific website to be accessed, so it is in essence part of the website

Provides Valuable Marketing Tools

The system prompts the user to bookmark the specified website the users other default browsers, and upon use, sends a message to a designated recipient, such as, for example but not by way of limitation, the marketing department of the business operating the accessed website, which message can be used to provide user information useful for marketing purposes. The information can be stored in a database.

Enables Date-sensitive Web Usage

The system can be utilized by businesses to provide users with various date-sensitive materials, such as, by way of non-limiting example, coupons toward discounts or other time-sensitive bonuses, corporate annual reports and shareholder communications, or help files.

The system utilizes known Internet communications protocols, links and hardware. Users of the system use and access the system through computer terminals connecting to the system through known methods of Internet connection and communication.

The combination of elements comprising the present system results in a system that can be easily used by any computer user, allowing advertisers, help desks, and others to direct traffic directly to their website simply and inexpensively.

### BRIEF DESCRIPTION OF THE DRAWINGS

FIG. 1 is a flow chart diagram of the procedure for installing and running the present system on a typical personal computer system.

FIG. 2(a) is a flow chart diagram describing the overall process flow of the customization process of the present invention in a preferred embodiment.

FIG. 2(b) is a flow chart diagram of the customization process of the present invention in a preferred embodiment at the browser customization stage.

### DESCRIPTION OF A PREFERRED EMBODIMENT

The present invention, in a preferred embodiment, is a customizable browser system for direct access to a specified Internet website comprising a browser software application that is programmable by a user to have the network address of said specified website as its home page address; an auto-execute software application that automatically executes said browser software application upon installation of said application's carrying media into a compatible computer system media reader; and computer software application storage media for storage of said browser software application and said auto-execute software application, which when inserted into a compatible computer system media reader of a computer system configured to access a computer network that provides access to said specified website, allows said auto-execute software application to run, launching said browser software application and thereby providing direct access to said specified website without further action being required by the end user of said system.

The present invention is also a computer-based method for direct access to a specified Internet website, comprising installing, into a compatible media reader communicating with a computer system that is configured to provide Internet access, computer software application storage media wherein is stored a browser software application that is programmable to have the network address of said specified website as its home page address, and an auto-execute software application that automatically executes said browser software application upon installation of said media into said media reader.

The present invention provides a system and computer-based method allowing the customized blending of designated websites and browser applications on a per-said-system-user basis. The system allow a user to “create” his or her own customized browser by selection of the customizable elements, including, but not limited to: the network address of the website automatically loaded when the browser is started (the “home page”), the background of the upper portion of the program (known as a “skin” on the “toolbar”), the look of the picture associated with an action (“button”) of returning the browser-program to the home page (the “park button”), the look of the button which exits the browser-program (the “exit button”) and the color of the graphical user interface (“GUI”) element which allows the user to view off-screen information (the “scroll bars”). After the browser has been customized, the complete browser is generated —allowing any computer system capable of using the browser to view the customized browser and website. The system also includes an auto-execute software application that automatically executes the browser software application upon insertion of the carrying media into a suitable computer system media reader of a computer system that is configured to access the Internet, e.g., which has a modem or other Internet communications device connected to a telephone line or other telecommunications service line enabling the computer system to access the Internet and the World Wide Web. The browser application and auto-execute application are stored on suitable computer software storage media, such as a computer diskette or cd-rom.

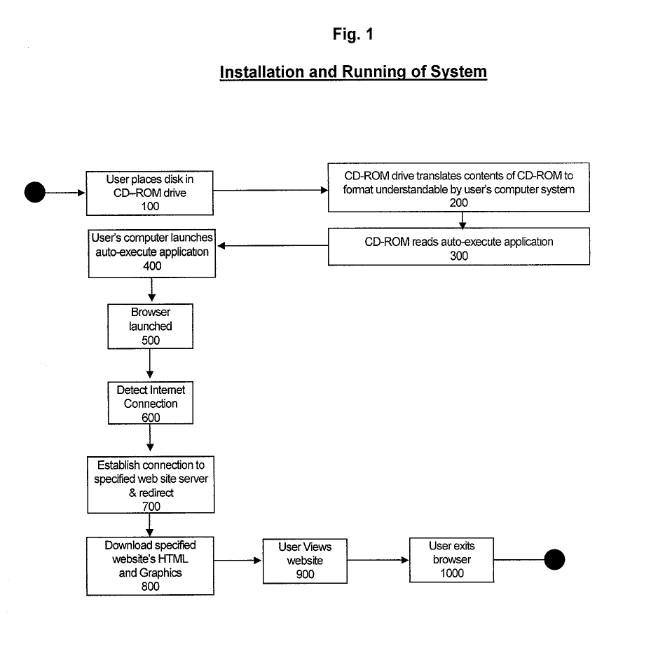

Referring now to FIG. 1, when the storage media in which the browser application browser is placed in a media reader 100 such as by saving the browser application to a computer disk or cd-rom and then installing the disk or cd-rom in the user's computer disk drive or cd-rom drive, as the case may be, the customized browser will automatically load the program and the specified website through the browser user's Internet connection. The media reader translates the cd-rom's contents to a format understandable by the user's computer system 200 and then reads the auto-execute software application 300. The user's computer then launches the auto-execute software application 400 and the browser is launched 500. The user's computer system Internet connection is detected 600 and connection to the specified website server is made 700. The specified website's HTML and graphics files are downloaded to the user's computer system 800 and the user can then view the specified website in its programmed format 900.

The browser is not intended as a full-functional browser (although it could be used in this way)—rather, it is a “temporary” browser, with the buttons and features for only the necessary functions (back, forward, quit, pack, print, as opposed to a browser such as Microsoft's Internet Explorer™ or Netscape's Mozzilla™ browsers with many features such as favorites and history). The browser also stays in the customized form even if the browser user leaves the specified website—thus “sticking” the user to the website. The buttons on the browser disappear and reappear in a context sensitive way. If, for example, a browser user is on the specified website associated with the “park” button, the “park” button will disappear and reappear when the browser user leaves the website associated with the park button. This allows for a more simplified user interface than the Microsoft Windows™ method of turning a button which has no current use a lighter shade of gray (“disabling” the button). When the browser user selects the quit button, the user will be prompted to bookmark the specified website in their default browser (such as MS Internet Explorer™).

The system provides a browser that can be blended with the website (although it need not be customized this way). Customizing the browser to blend with the website means that the colors of the website are used as the background color of the skin of the browser, and the title of the website (or the company's logo) is the foreground of the skin; the buttons are customized to match the website's look-and-feel; the scrollbar color is similarly customized to match the website's look-and-feel. Thus, when customized in this way, it is very difficult to distinguish where the area of the website ends and where the area of the browser starts.

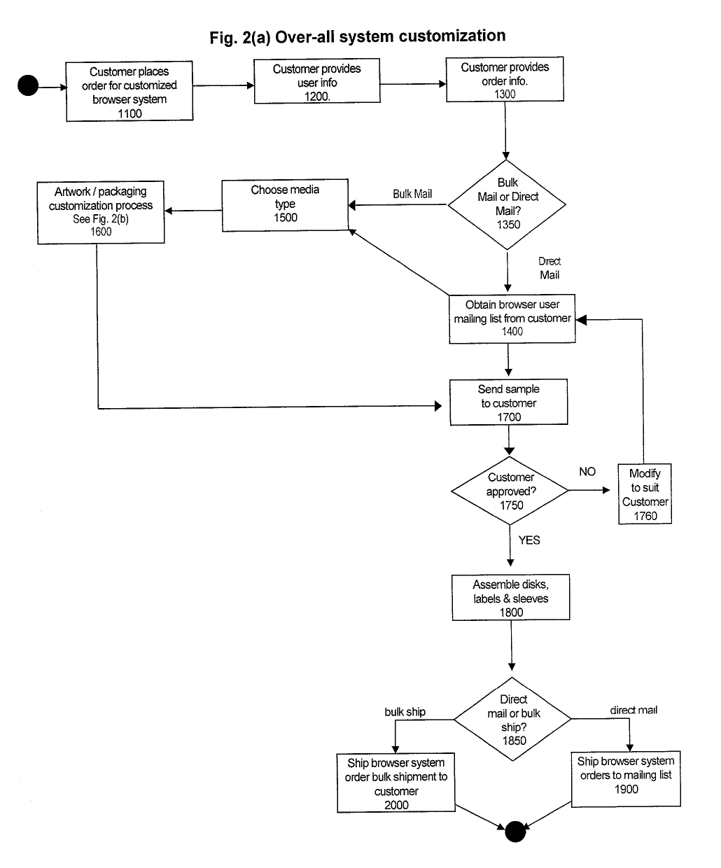

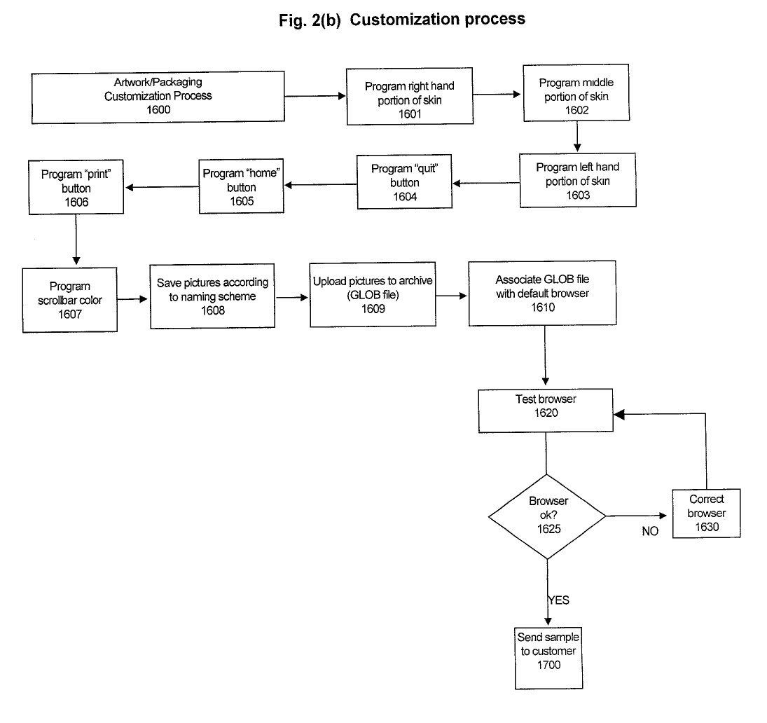

Referring now to FIG. 2(a), which describes the system customization process flow in a preferred embodiment, a customer, such as a business with a business-related website that wants to send out for example, diskettes or cd-roms to existing or potential customers with the customer's website address and look and feel programmed into the browser software application, would place an order for same with 1100 the provider of the system of the present invention. The customer provides its user information 1200 and order information 1300. If the customer wants the diskettes or cd-roms mailed directly to its intended recipients, a mailing list is provided by the customer 1400. The customer can also choose what storage media type to use 1500. The information is then used by system provider to create the customized browser 1600. A sample would be sent to the customer for approval 1750 and if approved, the media is packaged 1800 and shipped 1900 and 2000.

Referring now to FIG. 2(b), which describes the browser customization process flow in one embodiment, the system provider, in accordance with the customer's specifications, programs the “skin” graphical image of the browser (1601-1603) and then programs the browser buttons to be used (1604-1606). The scroll bar is programmed 1607 and other graphics are created and stored (1608-1610). The browser is then tested 1620 and if okay, the sample is sent to the customer 1700.

It should be recognized that the system could also be ordered online via the Internet as well, with information obtained and browser samples provided electronically. Additionally, the browser customization steps taken by a third party system provider as described above could alternately be handled by the “customer” itself, or even by the intended end user of the system if desired.

The system eliminates the cookie-cutter look-and-feel of the typical browser and greatly enhances the experience of viewing the website.

The browser system of the present invention also allows deep integration with the user and the website: it provides the ability to change the content of the website based on information about the browser user which is passed to the server housing the website (the web server). For example, upon installing the browser disk for the first time, the system could facilitate the website to have its content dynamically created to say “Hello<user name>”; where <user name>is the name of the browser user. In a preferred embodiment, the browser system can be programmed to allow the specified website to identify and track users accessing the website using the system and method of the present invention.

The customized integration of website content with system browser is accomplished through the following process: each time the browser is loaded, the browser number relative to all like-customized browsers (the serial number) is sent over the Internet through the process of opening a connection (socket), naming the socket and binding the socket to an address, which a person reasonably trained in the art could easily do. This socket process uses a secure Internet protocol to send data containing the browser's serial number as well as another number to identify the customer (the customer number) to a computer system associated with an Internet Protocol (IP) address capable of processing this request. The processing of the request includes the process of using a unique identifier (a key) to find (look up) some piece of data (a value) in a permanent data store (a database), with the customer number being the key and the value being the address of the website to load and the format of user's accounts Next, using the serial number as the key, the user information is looked up in the database. The user information is then converted and URL encoded to a format the web server hosting the website is able to process. Finally, a dynamically generated website containing a command to redirect the browser to the specific site (a redirect page) is generated, and the browser user is transported to the correct site with their information encoded in URL address of the website. Additionally in this process, each time a request comes for a certain customer number and serial number, a counter is incremented. This counting system provides a basis for advanced reporting/usage tracking functions, such as demographics versus hit rate, location versus hit rate, etc.

The system of the present invention also can catalog end-user use of the system on a per-use basis. Each time the browser is loaded, the number of the browser relative to all like-customized browsers (the “serial number”) is sent over the Internet using a secure Internet protocol. This information reaches an IP address on the Internet capable of receiving and processing response and requests of this protocol, which will store this data in a permanent datastore, which supports various reporting functions including a usage history.

The process of sharing user information with a website allows a website to appear to know a person's name, greatly enhancing the user experience. Additionally, any information at all can be passed to the web site, such as the age of the user, the gender of the user, the favorite color of the user, etc.; third, since the customer supplies the format their web server takes to obtain information, there is no need for the customer to spend any money on infrastructure changes to their existing system; fourth, the customer can receive detailed reports, and can even customize which reports they want; and fifth, the process takes place without knowledge of the user.

The entire process of integrating a website with a user may seem to rely on a user and a disk containing a browser be in a one-to-one relationship meaning only one person can use the disk. However, if the disk containing part of this browser system was direct mailed to a user family, this disk could contain a serial number corresponding to information about the family as a whole allowing as many people in that family to use that disk. Or, if disks containing the browser were handed out, for example, at a mall, the disks could contain a bulk serial number, corresponding to the fact that the user obtained the disk at the mall. Thus, the user can be a group, which is one disk to many users, or it can be many disks in one group (through bulk serialization), which allows one group to correspond to many disks. This makes the system extremely flexible in its potential applications.

The customization process extends from the look-and-feel of the browser (the look of the skin, buttons, scrollbars, etc) to the functionality of the browser (which website it goes to) and to content of the website (through the user information it sends). The system allows advertisers, marketers, direct mailers, and e-tailors the ability to connect groups of users (such as their mailing lists) to a specified website, complete with any desired information about the person/group. Additionally, the system allows a customer another powerful tool towards bridging the gap between online and offline business.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative and other embodiments may be selected without departing from the spirit and scope of the present invention.

What is claimed is:

1. A customizable browser system for direct access to a specified Internet website comprising:
a browser software application that is programmable to have the network address of said specified website as its home page address;
an auto-execute software application that automatically executes said browser software application upon installation of said application's carrying media into a compatible computer system media reader; and
computer software application storage media for storage of said browser software application and said auto-execute software application, which when inserted into a compatible computer system media reader of a computer system configured to access a computer network that provides access to said specified website, allows said auto-execute software application to run, launching said browser software application and thereby providing direct access to said specified website without further action being required by the end user of said system.

2. The customizable browser system of claim 1, wherein said browser software application has graphical features that are programmable to suit user preferences.

3. The customizable browser system of claim 1, wherein said browser software has graphical features that are programmable to match said specified website's geographical features.

4. The customizable browser system of claim 1, wherein said browser software application is programmed to allow said specified website to identify a user when said user accesses said specified website using said system.

5. The customizable browser system of claim 1, wherein said browser software application is programmed to allow said specified website to track user use of said system.

6. A computer-based method for direct access to a specified Internet website, comprising:
installing, into a compatible media reader communicating with a computer system that is configured to provide Internet access, computer software application storage media wherein is stored a browser software application that is programmable to have the network address of said specified website as its home page address, and an auto-execute software application that automatically executes said browser software application upon installation of said media into said media reader.
